(19) United States
(12) Patent Application Publication
(10) Pub. No.: US 2023/0132295 A1
(43) Pub. Date: Apr. 27, 2023

(54) DOMAIN CONTROL-BASED BATTERY MANAGEMENT SYSTEM

(71) Applicant: GAC AION NEW ENERGY AUTOMOBILE CO. LTD, Guangzhou (CN)

(72) Inventors: Bin Li, Guangzhou (CN); Zhao Ma, Guangzhou (CN); Ronglian Zou, Guangzhou (CN); Zhuo Chen, Guangzhou (CN)

(21) Appl. No.: 17/914,500

(22) PCT Filed: Jun. 8, 2021
(86) PCT No.: PCT/CN2021/098771

§ 371 Date: Sep. 26, 2022

(30) Foreign Application Priority Data
Aug. 21, 2020 (CN) 202010847564.4

(51) Int. Cl. B60L 58/22; B60R 16/02; B60L 50/64; B60L 58/24; H01M 10/42

(52) U.S. Cl. CPC B60L 58/22; B60R 16/0207; B60L 50/64; B60L 58/24; H01M 10/425; H01M 2010/4271; H01M 2220/20

(57) ABSTRACT

Provided is a domain control-based battery management system, comprising a domain controller (01), a power battery pack (02) and a daisy chain wire harness; the power battery pack (02) is provided with battery cells (021), acquisition plates (022) used for acquiring first battery parameters of the battery cells (021), and a high-voltage plate (023) used for acquiring second battery parameters of the power battery pack (02); the daisy chain wire harness comprises a first daisy chain (031) and a daisy chain branch (032); the first daisy chain (031) is connected between the domain controller (01) and the acquisition plates (022); and one end of the daisy chain branch (032) is connected to the high-voltage plate (023), and the other end of the daisy chain branch (032) is connected to the domain controller (01) by means of the first daisy chain (031). Said system can improve the safety of battery management and reduce the production cost of the power battery pack.

The present disclosure claims the priority of the Chinese invention patent application with the invention name “domain control-based battery management system” submitted to the China Patent Office on Aug. 21, 2020, application No. 202010847564.4, and the entire content of which is hereby incorporated by reference.

### TECHNICAL FIELD

The present disclosure relates to the field of new energy vehicles, and more specifically relates to a domain control-based battery management system.

### BACKGROUND

With the development of battery technology, alternative energy powered vehicles powered by batteries are gradually becoming popular. Existing alternative energy powered vehicles usually need an independent battery management system (BMS) to manage the battery pack. The vehicle controller and BMS to need to work together to ensure the normal operation of such vehicles. However, due to communication faults, such as communication rate, communication success rate, coordination of multiple controllers, etc., the compatibility and security of independent BMS are not high, causing problems during the operation of the vehicles and high cost of battery management software development.

### SUMMARY OF THE INVENTION

An object of the present disclosure is to provide a domain control-based battery management system to solve the problems of low security of a BMS and high cost of power battery packs in the prior art.

To achieve the above purpose, the technical solution adopted by the present disclosure is to provide a domain control-based battery management system, including a domain controller, a power battery pack, and a daisy chain harness; the domain controller integrating a vehicle controller and a BMS.

the power battery pack is provided with a plurality of battery cells connected in series, an acquisition plate for acquiring first battery parameters of the battery cells, and a high-voltage plate for acquiring second battery parameters of the power battery pack;

the daisy chain harness comprises a first daisy chain and a daisy branch chain; the first daisy chain is connected between the domain controller and the acquisition plate, one end of the daisy branch chain is connected to the high-voltage plate, and other end of the daisy branch chain is connected to the domain controller through the first daisy chain.

Optionally, the acquisition plate is provided with a plurality of battery front-end chips, and each of the battery front-end chips is serially connected head to tail through the first daisy chain; the acquisition plate collects the first battery parameters of the battery cell through the battery front-end chip.

Optionally, the daisy chain harness further comprises a second daisy chain connected between the domain controller and a tail end chip on the acquisition plate, and the tail end chip refers to a battery front-end chip which is arranged furthest from the domain controller on the first daisy chain.

Optionally, the high-voltage plate comprises a monitoring chip for collecting second battery parameters.

Optionally, the first battery parameters comprise voltage and balance of the battery cell and a battery temperature.

Optionally, the second battery parameters comprise total voltage, total current, electric quantity and insulation strength data of the power battery pack.

Optionally, the BMS includes a relay, the relay is connected to the power battery pack and configured to control power on state of the power battery pack.

Optionally, the power battery pack is provided with a sensor, and the vehicle controller comprises an AD sampling unit connected with the sensor and configured to collect an inductive signal of the sensor.

Optionally, the daisy chain harness is a twisted pair connection.

An automobile, the automobile includes a domain control-based battery management system, the domain control-based battery management system comprising a domain controller, a power battery pack, and a daisy chain harness; the domain controller integrates a vehicle controller and a BMS;

the power battery pack is provided with a plurality of battery cells connected in series, an acquisition plate for acquiring first battery parameters of the battery cells, and a high-voltage plate for acquiring second battery parameters of the power battery pack;

the daisy chain harness comprises a first daisy chain and a daisy branch chain; the first daisy chain is connected between the domain controller and the acquisition plate, one end of the daisy branch chain is connected to the high-voltage plate, and other end of the daisy branch chain is connected to the domain controller through the first daisy chain.

The beneficial effects of the domain control-based battery management system provided by the application are as follows: compared with the prior art, the domain controller set in the domain control-based battery management system of the present disclosure integrates the control functions of the original vehicle controller (VCU) and BMS on the vehicle, there is no need to set a controller in the power battery pack, which can reduce the number of controllers and the development difficulty and cost of battery control software. In the present disclosure, the circuit board in the power battery pack has only the high-voltage part, which can reduce the mutual interference between high and low voltage, increase the electrical clearance and creepage distance, and improve the safety of the power battery pack. Since the software control part (vehicle controller and BMS) is fully integrated in the domain controller, even if the power battery pack is replaced, the software control part in the domain controller does not need to be changed. The present disclosure can improve the safety of battery management while reducing the production cost of power battery packs.

The details of one or more embodiments of the present disclosure are set forth in the following drawings and descriptions, and other features and advantages of the present disclosure will become apparent from the description, drawings, and claims.

### BRIEF DESCRIPTION OF THE DRAWINGS

In order to more clearly explain the technical solutions of the present disclosure, the following will briefly introduce the embodiments or the drawings needed to be used in the description of the prior art. It is obvious that the drawings in the following description are only some embodiments of the present invention. For those of ordinary skill in the art, other drawings can also be obtained from these drawings without creative labor.

FIG. 1 is a schematic structural diagram of a domain control-based battery management system according to an embodiment of the present disclosure.

Reference numerals in the figures are:

01—domain controller; 011—AD sampling unit; 012—relay; 02—power battery pack; 021—battery cell; 022—acquisition plate; 0221—battery front-end chip; 023—high-voltage plate; 0231—monitoring chip; 031—first daisy chain; 032—daisy branch chain; 033—second daisy chain.

### DETAILED DESCRIPTION

In order to make the technical problems, technical solutions and beneficial effects to be solved by the present disclosure more clearly, the present disclosure will be further described in detail in combination with the accompanying drawings and embodiments. It should be understood that the specific embodiments described herein are only for explaining the present disclosure and are not intended to limit the present disclosure.

It should be noted that when an element is described as “fixed” or “set” to another element, it may be directly on the other element or indirectly on the other element. When an element is said to be “connected” to another element, it can be directly connected to another element or indirectly connected to the other element.

It should be understood that the orientation or positional relationship indicated by the terms “length”, “width”, “up”, “down”, “front”, “back”, “left”, “right”, “vertical”, “horizontal”, “top”, “bottom”, “inner” and “outer” are based on the orientation or positional relationship shown in the drawings, these are only for the convenience of describing the present disclosure and simplifying the description, they do not indicate or imply that the device or element must have a specific orientation, be configured, and operate in a specific orientation, and therefore cannot be understood as limiting the present disclosure.

In addition, the terms “first” and “second” are only used for descriptive purposes and cannot be understood as indicating or implying relative importance or implicitly indicating the number of indicated technical features. Thus, the features defined as “first” and “second” may explicitly or implicitly include one or more of the features. In the description of the present disclosure, “multiple” means two or more, unless otherwise specifically defined.

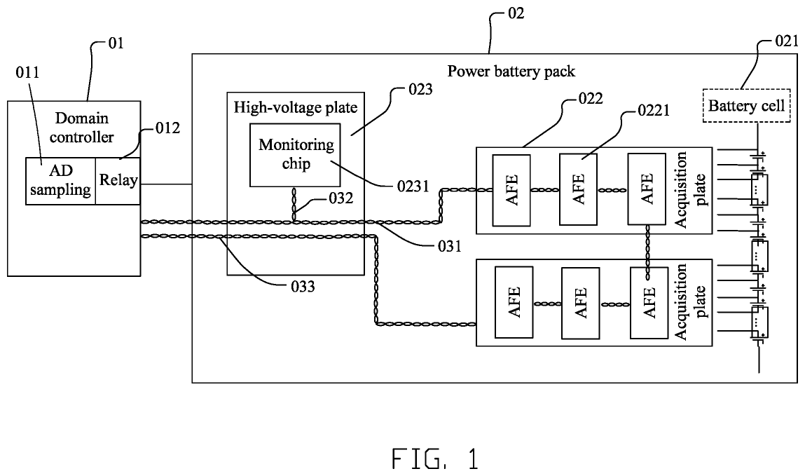

FIG. 1 shows the domain control-based battery management system provided by the present disclosure. The domain control-based battery management system includes a domain controller 01, a power battery pack 02, and a daisy chain harness. The domain controller 01 integrates a vehicle controller (not shown) and a BMS (not shown).

The power battery pack 02 is provided with a plurality of battery cells 021 connected in series, an acquisition plate 022 for acquiring first battery parameters of the battery cells 021, and a high-voltage plate 023 for acquiring second battery parameters of the power battery pack 02.

The daisy chain harness includes a first daisy chain 031 and a daisy branch chain 032, the first daisy chain 031 is connected between the domain controller 01 and the acquisition plate 022, one end of the daisy branch chain 032 is connected to the high-voltage plate 023, and the other end of the daisy branch chain 032 is connected to the domain controller 01 through the first daisy chain 031.

In the embodiment, the domain control-based battery management system is composed of and includes two parts, namely, the domain controller 01 and the power battery pack 02. The domain controller 01 and the power battery pack 02 are connected by a first daisy chain 031. Here, the domain controller 01 integrates some functions of the vehicle controller (VCU) and the BMS. The domain controller 01 integrates the functions of the original vehicle controller, including AD sampling (collecting analog signals), digital sampling, high and low side drive output, current valve control output, CAN communication (communicating with the vehicle's controller area network), LIN communication (communicating with the vehicle's local interconnect network), LAN communication (communicating with the vehicle's local area network), etc. Functions of integrated BMS include: battery pack AD sampling, battery pack relay 012 control, etc.

The power battery pack 02 mainly includes a high-voltage plate 023, an acquisition plate 022, and a battery cell 021. The high-voltage plate 023 has functions such as insulation detection, high-voltage detection, and current detection, which can be characterized by using the second battery parameters.

Optionally, the second battery parameters include but are not limited to the total voltage, total current, quantity of electrical power, and insulation strength data of the power battery pack 02.

In the embodiment, the second battery parameter may refer to the battery parameter measured by the monitoring chip 0231, including but not limited to the total voltage, total current, electric quantity, and insulation strength data of the power battery pack 02. The insulation strength data refers to the insulation strength between high-voltage components (the power battery pack 02) and low-voltage components (such as the domain controller 01).

The number of the acquisition plates 022 may be one or more. The acquisition plate 022 has a function of acquiring the first battery parameters of the battery cell 021. In the present disclosure, the first battery parameters include but is not limited to the voltage, temperature, and the like of the battery cell 021. The acquisition plate 022 can also realize the balanced control of each battery cell 021.

Optionally, the first battery parameters include but are not limited to the voltage, balance, and battery temperature of the battery cell 021.

Here, the first battery parameter may refer to the battery parameters measured by the battery front-end chip 0221, including but not limited to, the voltage, balance, and temperature of the battery cell 021. The power remaining and the state of health of the current battery cell 021 can be evaluated by the first battery parameter. For example, the remaining power can be estimated based on voltage change of the battery cell 021; The health state of the battery cell 021 can be evaluated according to the temperature (both an excessively high temperature and an excessively low temperature are unhealthy states).

The battery cell 021 is used to store electric energy and may be a power lithium battery. The power battery pack 02 includes a plurality of battery cells 021, which are usually connected in series.

The domain controller 01 and the power battery pack 02 can be connected by a daisy chain harness. The daisy chain harness includes a first daisy chain 031 and a daisy branch chain 032. The first daisy chain 031 is a communication line formed in a daisy chain topology. In the first daisy chain 031, each node on the acquisition plate 022 is sequentially connected in series. Each node can collect the first battery parameter of the battery cell 021. The first battery parameters collected by the node may be transmitted to the domain controller 01 through the first daisy chain 031.

The first daisy chain 031 is provided with a daisy branch chain 032 which is connected to the high-voltage plate 023. The second battery parameters collected by the high-voltage plate 023 can be transmitted to the domain controller 01 through the daisy branch chain 032 and the first daisy chain 031. Here, since the daisy branch chain 032 is directly connected to the first daisy chain 031 without passing through the acquisition plate 022, the high-voltage plate 023 and the acquisition plate 022 are connected in parallel.

In the domain control-based battery management system of the embodiment, the control functions of the VCU and BMS for the battery cell 021 are integrated in the domain controller 01, there is no need to set a controller in the power battery pack 02, so the number of controllers can be reduced, and the development difficulty and cost of battery control software can be reduced. The circuit board in the power battery pack 02 has only the high-voltage part, and the low-voltage part (the domain controller) is set outside the power battery pack 02, which can reduce the mutual interference between the high and low voltage, increase the electrical gap and creepage distance, and improve the safety of the battery. Moreover, the software control part is located in the domain controller 01, thus even if the power battery pack 02 is changed, the software control part in the domain controller 01 does not need to be changed.

Optionally, the daisy chain harness also includes a second daisy chain 033 connected between the domain controller 01 and the tail end chip on the acquisition plate 022. The tail end chip refers to the battery front-end chip 0221 set on the first daisy chain 031 at the farthest distance (communication distance) from the domain controller 01.

In one example, the second daisy chain 033 may be provided so that the second daisy chain 033 is connected to the tail end chip of the first daisy chain 031 (the battery front-end chip 0221 that is the farthest away from the communication distance of the domain controller 01). Furthermore, the first daisy chain 031 and the second daisy chain 033 form a closed loop, and both the starting point and the ending point are set on the domain controller 01. The advantage of utilizing the second daisy chain 033 is that even if a node in the middle is interrupted, collection of the first battery parameters and the second battery parameters is not affected. For example, if a certain node is interrupted, and a subsequent node cannot transmit data through the first daisy chain 031, and instead transmits data through the second daisy chain 033.

The acquisition plate 022 is optionally provided with several battery front-end chips 0221, each battery front-end chip 0221 is serially connected end to end through the first daisy chain 031. The acquisition plate 022 acquires the first battery parameters of the battery cell 021 through the battery front-end chip 0221.

In this embodiment, the battery front-end chip 0221 (AFE) can sample the voltage and temperature of each battery cell 021 and balance each battery cell 021. Each battery front-end chip 0221 is connected in series with each other through a first daisy chain 031. A battery front-end chip 0221 can be regarded as a node. The collected first battery parameters are transmitted section by section through the first daisy chain 031 and finally to the domain controller 01. The number of the acquisition plates 022 may be one or more. If the number of the acquisition plates 022 is multiple, each acquisition plate 022 is connected in series.

Optionally, the high-voltage plate 023 includes a monitoring chip 0231 for collecting second battery parameters.

Here, the monitoring chip 0231 may be an LTC2949 chip (a model of a battery chip). The monitoring chip 0231 can collect the total voltage and total current (belonging to the second battery parameter) output by the entire power battery pack 02 and can detect the insulation strength between the power battery pack 02 (high-voltage component) and low-voltage components such as the domain controller 01.

Optionally, the BMS includes a relay 012, which is connected to the power battery pack 02 and used to control the power on state of the power battery pack 02.

Here, a relay 012 may also be provided in the domain controller 01. The relay 012 can control the on/off of the power battery pack 02 to control the power on state of the power battery pack 02. The power on state of the power battery pack 02 mainly includes two types, namely, connected and disconnected.

Optionally, a sensor (not shown) is provided in the power battery pack 02, and the vehicle controller includes an AD sampling unit 011 connected to the sensor and used to collect the sensing signal of the sensor.

Here, the AD sampling unit 011 can collect the sensing signal of the sensor according to a preset sampling frequency. The sensor can be set according to actual needs. In one example, the sensor may be a pressure sensor. The pressure sensor can measure the pressure change inside the power battery pack 02. If the battery cell 021 bulges, the pressure sensor can detect abnormal pressure data.

Optionally, daisy chain harness is twisted pair.

In this embodiment, the daisy chain harness uses twisted pair as the communication line. The cost of twisted pair is low, which can reduce the production cost of the domain control-based battery management system.

An embodiment of the present disclosure also provides an automobile, the automobile includes the domain control-based battery management system. The domain control-based battery management system includes a domain controller, a power battery pack and a daisy chain harness. The domain controller integrates a vehicle controller and a BMS.

The power battery pack is provided with a plurality of battery cells connected in series, an acquisition plate for acquiring first battery parameters of the battery cells, and a high-voltage plate for acquiring second battery parameters of the power battery pack.

The daisy chain harness includes a first daisy chain and a daisy branch chain; the first daisy chain is connected between the domain controller and the acquisition plate, one end of the daisy branch chain is connected to the high-voltage plate, and the other end of the daisy branch chain is connected to the domain controller through the first daisy chain.

Optionally, the acquisition plate is provided with several battery front-end chips, and each battery front-end chip is serially connected head to tail through the first daisy chain; the acquisition plate acquires the first battery parameters of the cell through the battery front-end chip.

Optionally, the daisy chain harness further includes a second daisy chain connected between the domain controller and a tail end chip on the acquisition plate, and the tail end chip refers to a battery front-end chip arranged at the farthest position from the domain controller on the first daisy chain.

Optionally, the high-voltage plate includes a monitoring chip for collecting the second battery parameters.

Optionally, the first battery parameters include the voltage and balance of the battery cell and the battery temperature.

Optionally, the second battery parameters include total voltage, total current, electric quantity, and insulation strength data of the power battery pack.

Optionally, the BMS includes a relay, which is connected to the power battery pack and used to control the power on state of the power battery pack.

Optionally, the power battery pack is provided with a sensor, and the vehicle controller includes an AD sampling unit connected to the sensor and used to collect the sensing signal of the sensor.

Optionally, the daisy chain harness is a twisted pair.

The above is only the preferred embodiment of the present disclosure and does not limit the application. Any modification, equivalent replacement and improvement made within the spirit and principles of the present disclosure shall be included in the protection scope of the present disclosure.

1. A domain control-based battery management system comprising a domain controller, a power battery pack and a daisy chain harness; the domain controller be adapted to integrate a vehicle controller and a batter management system (BMS), wherein
the power battery pack is provided with a plurality of battery cells connected in series, an acquisition plate configured for acquiring first battery parameters of the battery cells, and a high-voltage plate configured for acquiring second battery parameters of the power battery pack; and
the daisy chain harness comprises a first daisy chain and a daisy branch chain; the first daisy chain is connected between the domain controller and the acquisition plate, one end of the daisy branch chain is connected to the high-voltage plate, and other end of the daisy branch chain is connected to the domain controller through the first daisy chain.

2. The domain control-based battery management system according to claim 1, wherein the acquisition plate is provided with a plurality of battery front-end chips, and each of the battery front-end chips is serially connected head to tail through the first daisy chain; the acquisition plate collects the first battery parameters of the battery cell through the battery front-end chip.

3. The domain control-based battery management system according to claim 2, wherein the daisy chain harness further comprises a second daisy chain connected between the domain controller and a tail end chip on the acquisition plate, wherein the tail end chip is a battery front-end chip at a farthest position from the domain controller on the first daisy chain.

4. The domain control-based battery management system according to claim 1, wherein the high-voltage plate comprises a monitoring chip configured for collecting second battery parameters.

5. The domain control-based battery management system according to claim 1, wherein the first battery parameters comprise a voltage value and a balance of the battery cell and a battery temperature.

6. The domain control-based battery management system according to claim 1, wherein the second battery parameters comprise a total voltage value, a total current value, an electric quantity, and an insulation strength data of the power battery pack.

7. The domain control-based battery management system according to claim 1, wherein the BMS comprises a relay, the relay is connected to the power battery pack and configured to control the power battery pack to power on or off.

8. The domain control-based battery management system according to claim 1, wherein the power battery pack is provided with a sensor, and the vehicle controller comprises an AD sampling unit connected with the sensor and is configured to collect an inductive signal of the sensor.

9. The domain control-based battery management system according to claim 1, wherein the daisy chain harness is a twisted pair.

10. An automobile comprising a domain control-based battery management system, the domain control-based battery management system comprising a domain controller, a power battery pack and a daisy chain harness; the domain controller be adapted to integrate a vehicle controller and a batter management system (BMS), wherein
the power battery pack is provided with a plurality of battery cells connected in series, an acquisition plate configured for acquiring first battery parameters of the battery cells, and a high-voltage plate configured for acquiring second battery parameters of the power battery pack; and
the daisy chain harness comprises a first daisy chain and a daisy branch chain; the first daisy chain is connected between the domain controller and the acquisition plate, one end of the daisy branch chain is connected to the high-voltage plate, and other end of the daisy branch chain is connected to the domain controller through the first daisy chain.

11. The automobile according to claim 10, wherein the acquisition plate is provided with a plurality of battery front-end chips, and each of the battery front-end chips is serially connected head to tail through the first daisy chain; the acquisition plate collects the first battery parameters of the battery cell through the battery front-end chip.

12. The automobile according to claim 11, wherein the daisy chain harness further comprises a second daisy chain connected between the domain controller and a tail end chip on the acquisition plate, wherein the tail end chip is a battery front-end chip at a farthest position from the domain controller on the first daisy chain.

13. The automobile according to claim 10, wherein the high-voltage plate comprises a monitoring chip configured for collecting second battery parameters.

14. The automobile according to claim 10, wherein the first battery parameters comprise a voltage value and a balance of the battery cell and a battery temperature.

15. The automobile according to claim 10, wherein the second battery parameters comprise a total voltage value, a total current value, an electric quantity, and an insulation strength data of the power battery pack.

16. The automobile according to claim 10, wherein the BMS comprises a relay, the relay is connected to the power battery pack and configured to control the power battery pack to power on or off.

17. The automobile according to claim 10, wherein the power battery pack is provided with a sensor, and the vehicle controller comprises an AD sampling unit connected with the sensor and is configured to collect an inductive signal of the sensor.

18. The automobile according to claim 10, wherein the daisy chain harness is a twisted pair.
